(19) United States
(12) Patent Application Publication
(10) Pub. No.: US 2024/0013287 A1
(43) Pub. Date: Jan. 11, 2024

(54) REAL TIME VISUAL FEEDBACK FOR AUGMENTED REALITY MAP ROUTING AND ITEM SELECTION

(71) Applicant: Capital One Services, LLC, McLean, VA (US)

(72) Inventors: Salik SHAH, Washington, DC (US); Timur SHERIF, Silver Spring, MD (US); Michael MOSSOBA, Great Falls, VA (US)

(21) Appl. No.: 17/811,128

(22) Filed: Jul. 7, 2022

(51) Int. Cl. G06Q 30/06; G06T 19/00

(52) U.S. Cl. CPC G06Q 30/0639; G06Q 30/0631; G06T 19/006

(57) ABSTRACT

In some implementations, a device may determine a route through an entity location to an item location for at least one item included in one or more items associated with a task. The device may provide routing AR information associated with the route to cause an AR view of the route to be displayed. The device may receive visual media that is associated with a first item. The device may analyze the visual media to determine whether an item depicted by the visual media is the first item, and/or one or more recommended items, associated with the first item, depicted by the visual media. The device may provide presentation information to cause AR feedback information to be displayed by the client device in connection with the visual media, wherein the AR feedback information identifies whether the item is the first item, and/or the one or more recommended items.

### BACKGROUND

Augmented reality (AR) may refer to a live view of a physical, real-world environment that is modified by a computing device to enhance an individual's current perception of reality. In augmented reality, elements of the real-world environment are “augmented” by computer-generated or extracted input, such as sound, video, graphics, haptics, and/or global positioning system (GPS) data, among other examples. Augmented reality may be used to enhance and/or enrich the individual's experience with the real-world environment.

### SUMMARY

Some implementations described herein relate to a system for providing real time visual feedback for augmented reality (AR) map routing and item selection. The system may include one or more memories and one or more processors coupled to the one or more memories. The one or more processors may be configured to receive an indication of one or more items associated with a task, wherein the one or more items are associated with an entity location. The one or more processors may be configured to determine a route through the entity location to an item location for each item included in the one or more items. The one or more processors may be configured to transmit, to a device, routing AR information associated with the route to cause an AR view of the route to be displayed by the device. The one or more processors may be configured to receive, from the device, an image captured by the device that is associated with a first item of the one or more items. The one or more processors may be configured to analyze, using a computer vision technique or another technique, the image to determine at least one of: whether an item depicted in the image is the first item, or one or more recommended items, associated with the first item, depicted in the image. The one or more processors may be configured to transmit, to the device, item AR information associated with the image to cause AR feedback information to be displayed by the device in connection with the image, wherein the AR feedback information identifies at least one of whether the item depicted in the image is the first item, or the one or more recommended items.

Some implementations described herein relate to a method for providing real time visual feedback for AR map routing and item selection. The method may include receiving, by a device, an indication of one or more items associated with a task, wherein the one or more items are associated with an entity location, and wherein the one or more items are associated with a user device. The method may include determining, by the device, a route through the entity location to an item location for at least one item included in the one or more items. The method may include providing, by the device and to a client device, routing AR information associated with the route to cause an AR view of the route to be displayed by the client device. The method may include receiving, by the device and from the client device, visual media captured by the device that is associated with a first item of the one or more items. The method may include analyzing, by the device, the visual media to determine at least one of: whether an item depicted by the visual media is the first item, or one or more recommended items, associated with the first item, depicted by the visual media. The method may include providing, by the device and to the client device, presentation information to cause AR feedback information to be displayed by the client device in connection with the visual media, wherein the AR feedback information identifies at least one of whether the item depicted by the visual media is the first item, or the one or more recommended items in the visual media.

Some implementations described herein relate to a non-transitory computer-readable medium that stores a set of instructions for a client device. The set of instructions, when executed by one or more processors of the client device, may cause the client device to receive an indication of one or more items associated with a task, wherein the one or more items are associated with an entity location. The set of instructions, when executed by one or more processors of the client device, may cause the client device to obtain routing AR information associated with a route through the entity location to an item location for each item included in the one or more items. The set of instructions, when executed by one or more processors of the client device, may cause the client device to provide, based on the routing AR information, an AR view of the route for display by the client device. The set of instructions, when executed by one or more processors of the client device, may cause the client device to obtain item AR information associated with visual media captured by the client device that identifies at least one of whether an item depicted by the visual media is included in the one or more items, or one or more recommended items depicted by the visual media. The set of instructions, when executed by one or more processors of the client device, may cause the client device to provide, based on the item AR information, AR feedback information for display in connection with the visual media.

### BRIEF DESCRIPTION OF THE DRAWINGS

FIGS. 1A-1D are diagrams of an example implementation relating to real time visual feedback for augmented reality (AR) map routing and item selection, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of one or more devices of FIG. 2, in accordance with some embodiments of the present disclosure.

FIGS. 4 and 5 are flowcharts of example processes relating to real time visual feedback for AR map routing and item selection, in accordance with some embodiments of the present disclosure.

### DETAILED DESCRIPTION

The following detailed description of example implementations refers to the accompanying drawings. The same reference numbers in different drawings may identify the same or similar elements.

In some cases, a user (e.g., an employee) may perform a task that includes obtaining one or more items from various locations at which the one or more items are stored. For example, the task may be associated with a list of requested items. The user may search an entity location to attempt to retrieve the items included in the list. The user may use a device (e.g., a client device) to assist in performing the task. For example, the client device may display the list of items to be retrieved.

However, it may be difficult to determine an efficient route through the entity location to retrieve all of the items included in the list. For example, different entity locations may be associated with different item locations, different checkout locations, different entry locations, different aisle layouts or configurations, and/or different exit locations, among other examples. As a result, the user may follow a route through the entity location that consumes significant time associated with retrieving the items included in the list.

Additionally, certain items may be associated with characteristics or attributes that are difficult to define and/or identify. For example, an item may be associated with a characteristic or attribute that is subjective and an interpretation of the characteristic or attribute may vary from person to person. As a specific example, a fruit may be associated with a level of ripeness. Some users may prefer the fruit at a first level of ripeness whereas other users may prefer the same fruit at a different level of ripeness. Additionally, two users may consider the same fruit to have different levels of ripeness. Therefore, it may be difficult to provide accurate instructions to the user performing the task to select an item having the correct characteristics or attribute when the characteristics or attribute are subjective. As a result, the user may select an item from the list having a different characteristic or attribute than desired or intended. This may result in the task being re-requested (e.g., via one or more devices) and/or re-performed, consuming time and/or resources (e.g., computing resources, network resources, and/or power resources) associated with a client device use by the user to perform the task.

Further, in some cases, an item included in the list may be unavailable or out of stock. Therefore, the user may be required to select a replacement item. However, it may be difficult to identify and/or select suitable replacement items for a given item because different users may prefer different replacement items for the same item. As a result, the user may select a replacement item that is not acceptable. This may result in the task being re-requested (e.g., via one or more devices) and/or re-performed, consuming time and/or resources (e.g., computing resources, network resources, and/or power resources) associated with a client device use by the user to perform the task.

Some implementations and techniques described herein enable real time visual feedback for augmented reality (AR) map routing and item selection. For example, a server device may receive an indication of one or more items associated with a task. The server device may determine a route through the entity location to an item location for each item included in the one or more items. The server device may transmit, to a client device, routing AR information associated with the route to cause an AR view of the route to be displayed by the client device.

In some implementations, the server device may receive, from the client device, visual media (e.g., one or more images, a video, or video streaming data) captured by the client device that is associated with a first item of the one or more items. The server device may analyze (e.g., using a computer vision technique and/or another technique) the visual media to determine whether an item depicted by the visual media is the first item, and/or one or more recommended items, associated with the first item, depicted by the visual media, among other examples. The server device may provide, to the client device, presentation information to cause AR feedback information to be displayed by the client device in connection with the visual media. In some implementations, the AR feedback information may identify whether the item depicted by the visual media is the first item, and/or the one or more recommended items in the visual media, among other examples.

In this way, the user performing the task may be enabled to quickly and easily be routed through an entity location (e.g., via the AR view of the route) to the one or more items. Additionally, the server device (e.g., a computer vision model or another machine learning model) may be trained to recognize and/or identify attributes or characteristics of items that may otherwise be subjective based on the judgement of a human. The AR feedback information may enable the user to identify a correct item having a certain desired attribute or characteristic, such as a certain level of ripeness of a fruit, among other examples. As a result, the server device may conserve time and/or resources (e.g., computing resources, network resources, and/or power resources) that would otherwise be used associated with the task being re-requested (e.g., via one or more devices) and/or re-performed by providing AR feedback to enable a user to quickly and easily identify the correct item and/or a suitable replacement item, among other examples. Additionally, the server device may conserve time associated with performing the task by efficiently routing the user through an entity location to locate the one or more items associated with the task.

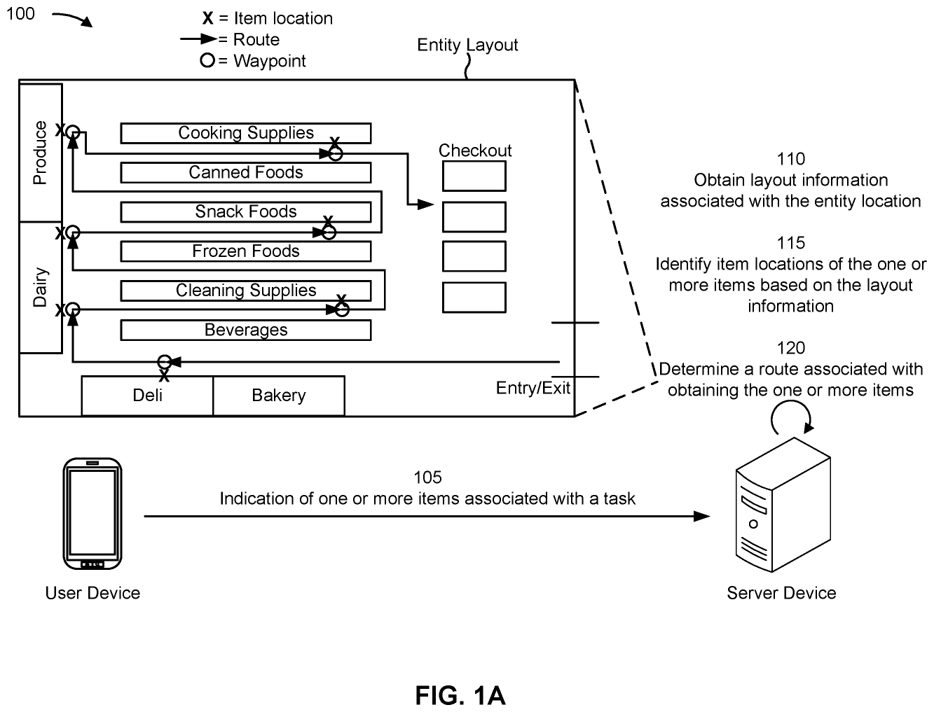

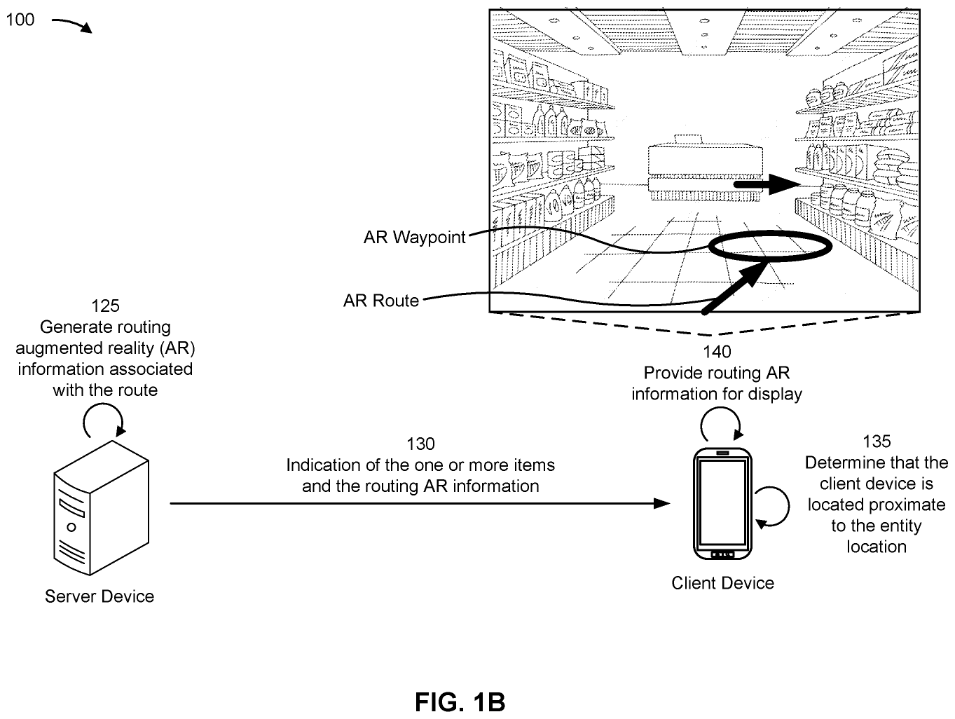

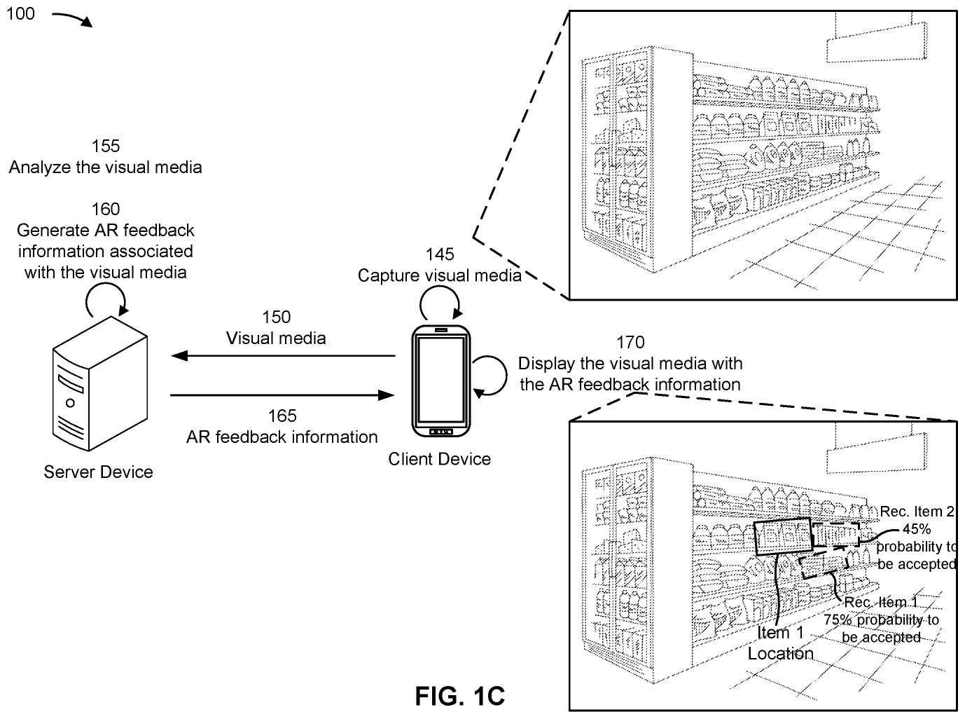

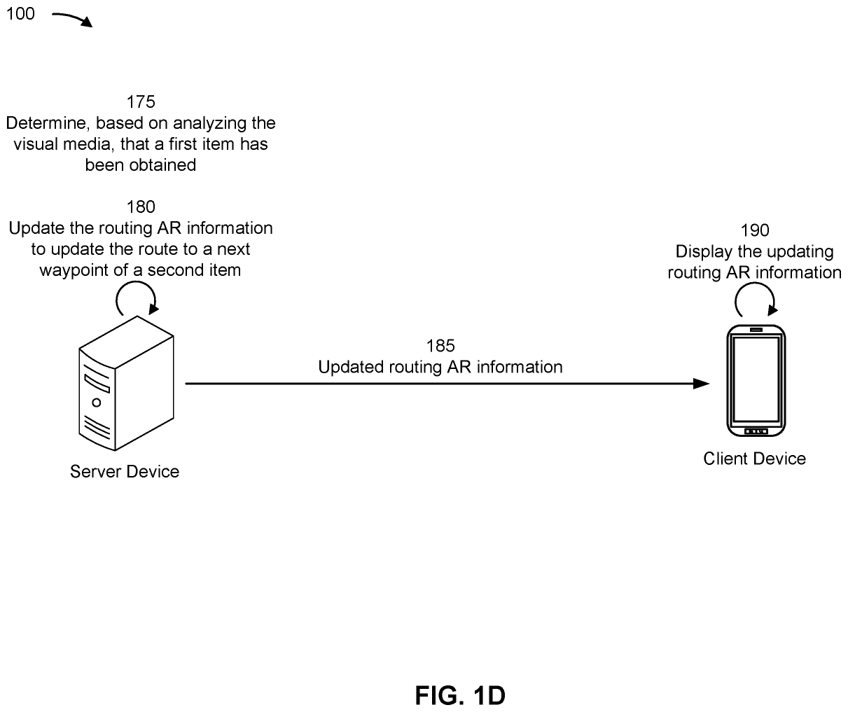

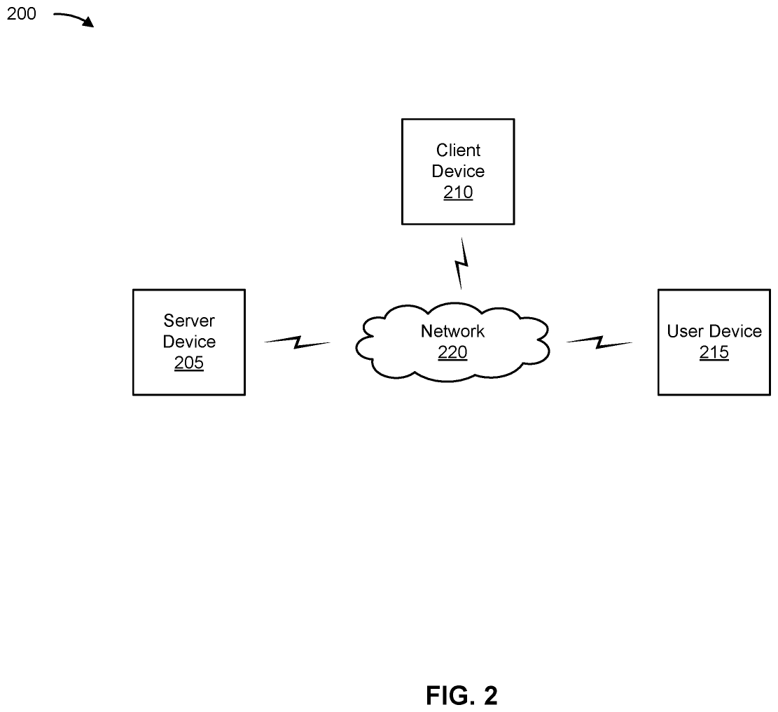

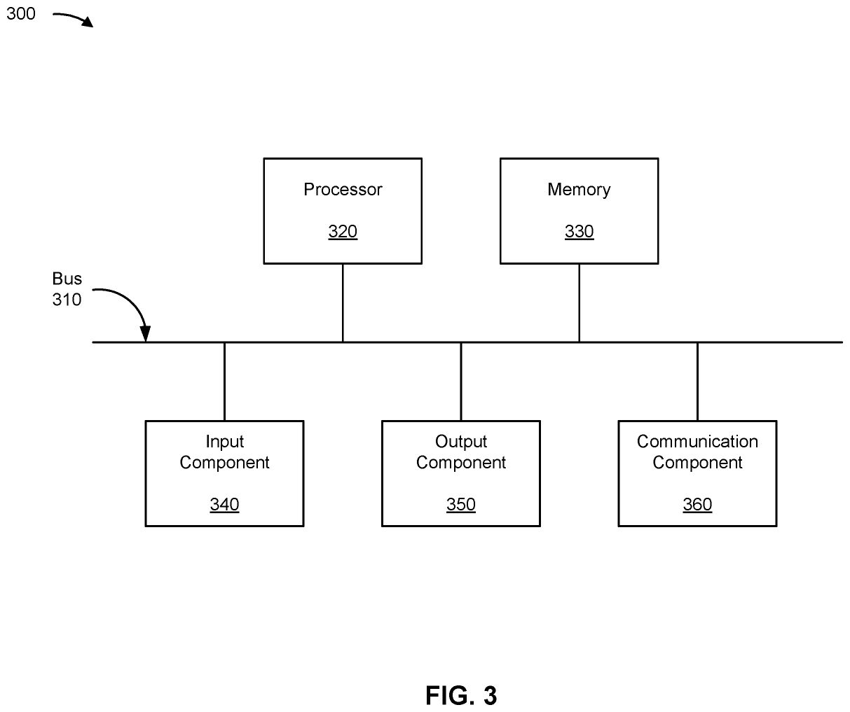

FIGS. 1A-1D are diagrams of an example 100 associated with real time visual feedback for AR map routing and item selection, in accordance with some embodiments of the present disclosure. As shown in FIGS. 1A-1D, example 100 includes a server device, a user device, and a client device. These devices are described in more detail in connection with FIGS. 2 and 3. In some implementations, the server device described herein may be included in, or associated with, the client device. For example, in some cases, the client device and the server device may be included in a single device. In other examples, the client device and the server device may be separate devices.

Although some examples may be described herein in connection with AR, extended reality (XR), mixed reality (MR), and/or virtual reality (VR) techniques may be used in a similar manner as described herein. For example, AR generally refers to interactive technologies in which objects in a real-world environment are augmented using computer-generated virtual content that may be overlaid on the real-world environment. MR, sometimes referred to as “hybrid reality,” similarly merges real and virtual worlds to produce a visual environment in which real physical objects and virtual digital objects can co-exist. However, in addition to overlaying virtual objects on the real-world environment, mixed reality applications often anchor the virtual objects to the real world and allow users to interact with the virtual objects. VR refers to fully immersive computer-generated experiences that take place in a simulated environment, often incorporating auditory, visual, haptic, and/or other feedback mechanisms. Although some examples may be described only in connection with AR techniques, XR, MR, VR, and/or a combination of the techniques may be used in connection with operations described herein.

As shown in FIG. 1A, a first user (e.g., a customer, an employer, and/or another user) may use the user device to initiate a task. For example, the task may be associated with acquiring one or more items (e.g., food, clothing, cleaning supplies, home goods, and/or any other item). In some implementations, that task may be associated with a third-party service. For example, the third-party service may be associated with acquiring and/or delivering requested items to a user (e.g., a third-party shopping and/or delivery service). For example, the third-party service may be an e-commerce platform (e.g., an e-commerce storefront), a food delivery service, an item delivery service, and/or a third-party shopper service, among other examples. In some other examples, the task may be associated with an employer (e.g., an employer may request an employee to obtain the one or more items). In some other examples, the task may be associated with a user acquiring the one or more items on their own behalf. In such examples, the user device and the client device described herein may be the same device and/or may be used by the same user to perform the operations described herein.

As shown by reference number 105, the user device may transmit, and the server device may receive, an indication of one or more items associated with a task. The one or more items may be items to be purchased for, or by, the first user. For example, the first user may select and/or purchase the one or more items via the user device. For example, the first user may use an application executing on the user device or a web page, among other examples, to select and/or purchase the one or more items. The task may be associated with acquiring the one or more items. In other words, the task may be associated with completing an order for the one or more items. For example, the server device may be associated with the third-party service that acquires and/or delivers the one or more items to the first user. In some implementations, the user device may be associated with an account and/or the first user. For example, the account may be associated with the third-party service that acquires and/or delivers the one or more items to the first user. The first user may initiate the task by signing into the account (e.g., via the user device), selecting the one or more items, and purchasing or requesting the one or more items.

In some implementations, the one or more items may be associated with an entity. For example, the first user may purchase the one or more items from an entity (e.g., a store, a vendor, and/or a merchant). Additionally, or alternatively, the one or more items may be associated with multiple entities (e.g., the one or more items may be purchased from multiple entities). For example, the one or more items may be associated with an entity location (e.g., a given location associated with an entity), such as a physical store (e.g., a brick-and-mortar building), a marketplace, or other location.

Based on receiving the indication of the one or more items, the server device may configure the task to be performed by a second user (or the first user in some cases). In some implementations, the server device may determine one or more replacement items. For example, for a first item from the one or more items, the server device may determine one or more replacement items. A replacement item may refer to an item that may be acquired or purchased instead of another item. For example, the server device may determine one or more replacement items that would be acceptable to the first user. A replacement item may also be referred to as a recommended item or an alternative item herein (e.g., the one or more recommended items may be replacement items or alternative items for the first item). In some implementations, a recommended item may not be a replacement for an item, but rather may include a recommended attribute or characteristic associated with a given item.

In some implementations, the server device may determine, for the first item, the one or more recommended items based on user information associated with an account that is associated with the task, exchange history (e.g., transaction history) information associated with the account, and/or item information associated with the first item, among other examples. For example, the user information associated with the account may include information associated with the first user, such as an age, a gender, residence information (e.g., a town, a county, a city, state, and/or a country in which the first user lives), race, and/or similar information associated with the first user. For example, the information associated with the first user may provide insight as to which replacement items and/or which attributes of a given item may be acceptable for the first user. For example, a female user may typically prefer a first attribute of an item or a first replacement item for the item, whereas a male user may typically prefer a second attribute of the item or a second replacement item for the item. As another example, a younger user (e.g., with an age under 30 years old) may typically prefer a first attribute of an item or a first replacement item for the item, whereas an older user (e.g., with an age over 30 years old) may typically prefer a second attribute of the item or a second replacement item for the item.

Additionally, or alternatively, the user information may include economic information associated with the first user, such as a credit history, an employment history, and/or an income history, among other examples. The economic information may be used by the server device to determine the one or more recommended items and/or one or more attributes of the recommended item. For example, a user with a higher income may prefer a first brand associated with an item, whereas a user with a lower income may prefer a second brand associated with the item. Additionally, or alternatively, the user information may include a user profile. The user profile may include information input by the first user. For example, the user may provide answers to a questionnaire. The answers to the questionnaire may provide an insight as to which replacement items and/or which attributes of a given item may be acceptable for the first user.

The exchange history (e.g., transaction history) information associated with the account may indicate previous transactions completed by the first user (e.g., via the service associated with the server device). For example, the exchange history may indicate previous transactions associated with the first user that include a given item. The server device may determine one or more attributes associated with the given item that are preferred by the first user (e.g., based on attributes of previously purchased items by the first user). As another example, the server device may determine one or more replacement items that may be acceptable for the first user based on similar items that have been previously purchased by the first user. Additionally, or alternatively, the exchange history (e.g., transaction history) information associated with the account may indicate previous transactions completed by the first user at other entities and/or via other services. For example, the first user may provide approval for a financial institution to provide the exchange history to the server device. The exchange history may indicate entities, merchants, vendors, and/or other locations at which the first user typically or frequently shops. The server device may determine that the first user may prefer a well-known brand (e.g., a famous brand, a popular brand or a “name brand”) or a more expensive brand associated with a given item (e.g., for the item or as a replacement item) if the exchange history indicates that the first user shops at other locations associated with the brand or shops at locations associated with more expensive items (e.g., “high end” locations). As another example, the server device may determine that the first user may prefer a less expensive brand (e.g., a discount brand or a “store brand”) associated with a given item (e.g., for the item or as a replacement item) if the exchange history indicates that the first user shops at other locations associated with the brand or shops at locations associated with less expensive items (e.g., “discount” locations).

Additionally, or alternatively, the server device may determine, for the first item, the one or more recommended items based on information associated with the first item, such as a category, a type, a cost, a quantity, and/or a brand, among other examples. For example, the server device may determine a replacement item for the first item that is associated with a similar, or the same, category, type, cost, quantity, and/or brand, among other examples, as the first item.

In some implementations, the server device may determine, for a recommended item, a quantity of the recommended item, one or more attributes of the recommended item, and/or a brand associated with the recommended item. For example, the one or more recommended attributes may include a size of an item (e.g., two pounds of beef, and/or 16 ounces of water, among other examples), a quantity of pieces associated with an item (e.g., two cloves of garlic, and/or four bananas, among other examples), a ripeness level associated with an item (e.g., unripe or ripened), a texture associated with an item, and/or a color associated with an item, among other examples. For example, the one or more recommended attributes may include objective attributes, such as size and/or quantity of pieces, among other examples, and subjective attributes, such as ripeness level and/or texture, among other examples.

For example, the server device may determine a recommended item associated with the first item. For example, a first item may be associated with a size of 24 ounces. The server device may determine a recommended replacement item for the first item (e.g., based on one or more considerations described in more detail elsewhere herein). The recommended replacement item may be associated with a size of 8 ounces. Therefore, the server device may determine that three recommended replacement items (e.g., three pieces) should be recommended to replace the first item (e.g., to ensure that 24 ounces total are selected to replace the first item).

In some implementations, the server device may determine one or more recommended attributes associated with a given item based on the user information associated with an account that is associated with the task, the exchange history information associated with the account, and/or the item information associated with the given item, among other examples (e.g., in a similar manner as described above). Additionally, or alternatively, the server device may determine the one or more recommended attributes based on an input received from the user device. For example, the first user may request an attribute (e.g., a size, quantity, ripeness level, texture, and/or color, among other examples) when selecting a given item. The indication of the one or more items received by the server device may include an indication of one or more recommended (e.g., requested) attributes associated with at least one item of the one or more items.

In some implementations, the server device may use a machine learning model to predict a likelihood that a given attribute or a given replacement item, for an item requested by the first user, will be acceptable to the first user. For example, the server device may train the machine learning model using the user information associated with an account that is associated with the task, the exchange history information associated with the account, and/or the item information associated with the given item, among other examples. For example, an input to the machine learning model may include information associated with a given attribute or a given replacement item, the user information associated with an account that is associated with the task, the exchange history information associated with the account, and/or the item information associated with the given item, among other examples. An output of the machine learning model may include a likelihood that the given attribute or the given replacement item will be acceptable to the first user. For example, the output may indicate “yes” (e.g., indicating that the given attribute or the given replacement item will be acceptable to the first user) or “no” (e.g., indicating that the given attribute or the given replacement item will not be acceptable to the first user). As another example, the output may be a score (e.g., from 0 to 100, where a score closer to 100 indicates a higher likelihood that the given attribute or the given replacement item will be acceptable to the first user) or a probability value (e.g., a percentage value, where a percentage closer to 100% indicates a higher likelihood that the given attribute or the given replacement item will be acceptable to the first user), among other examples. A probability value may indicate a likelihood that a user (e.g., the first user) would accept a recommended item as a replacement for the a given item. The server device may determine the one or more recommended items and/or the one or more recommended attributes based on the output of the machine learning model.

Additionally, the server device may determine a route through an entity location to an item location for each item included in the one or more items (e.g., that are associated with the entity). For example, as shown by reference number 110, the server device may obtain layout information associated with the entity location. The layout information may indicate a layout associated with the entity location. For example, the layout information may indicate locations of aisles, displays, entrances, exits, checkout locations, and/or department locations, among other examples. An example entity layout is depicted in FIG. 1A including a bakery department, a deli department, a dairy department, a produce department, and multiple aisles containing items included in various categories. For example, within the entity location, items may be grouped according to a category associated with the items (e.g., all canned foods may be located in the aisle associated with canned foods).

As shown by reference number 115, the server device may identify and/or determine item locations of the one or more items based on the layout information. In some implementations, the layout information may indicate item locations of various items associated with (e.g., offered for sale in) the entity location. For example, the layout information may indicate, within the layout associated with the entity location, a location of various items. Additionally, or alternatively, the server device may determine item locations associated with the one or more items associated with the entity location. For example, the server device may identify a category associated with an item included in the one or more items (e.g., an apple may be associated with a category of fruit or produce, water may be associated with a category of beverages, among other examples). The server device may identify an aisle, department, and/or display, among other examples, associated with the category based on the layout information. The server device may determine that the item is located in the aisle, the department, and/or the display.

In some implementations, the server device may determine a precise location of an item (e.g., a shelf location or a bay location) based on an identifier associated with the item. For example, the item may be associated with a stock keeping unit (SKU) or another identifier. The server device may store information indicating locations associated with various SKUs. For example, a given SKU may be associated with an aisle and a bay number (e.g., indicating a precise location of the item within the aisle). A bay may refer to a set of shelves or a length of shelving within an aisle. The server device may perform a lookup operation to identify item locations (e.g., an aisle and a bay) associated with each of the one or more items.

As shown by reference number 120, the server device may determine the route associated with obtaining the one or more items based on determine the item locations for the one or more items. For example, the server device may determine one or more waypoints, associated with the route, corresponding to the item location for each item included in the one or more items. A waypoint may refer to a stopping point along the route. For example, the server device may create a waypoint for each item location associated with the one or more items.

The server device may determine an order of the one or more waypoints based on the layout information. For example, the server device may determine the route by ordering the waypoints associated with the one or more items in an efficient manner. For example, as shown in FIG. 1A, the server device may determine to order the waypoints such that the route is a shortest length possible (e.g., such that the route does not double back on itself, or does not cross the entire entity layout multiple times). In some implementations, the server device may determine the order of the waypoints based on an entry/exit location. For example, the server device may determine that a first waypoint is to be the waypoint that is closest to the entry/exit location. Additionally, or alternatively, the server device may determine the order of the waypoints based on a checkout location. For example, the server device may determine that a last waypoint is to be the waypoint that is closest to the checkout location.

In this way, the server device may efficiently route a shopper or user through the store to obtain the one or more items requested by the first user. For example, a shopper (e.g., the first user or a second user) may conserve time associated with locating the one or more items. Additionally, the shopper may conserve time that would have otherwise been used with a suboptimal route through the entity location. Further, the shopper may conserve time and resources (e.g., network resources, processing resources, and/or power resources) that would have otherwise been used searching for one or more item location (e.g., using a device, such as the user device or the client device (not shown in FIG. 1A).

As shown in FIG. 1B, and by reference number 125, the server device may generate AR information (e.g., routing AR information) associated with the route. In some implementations, the AR information may include presentation information that is configured to cause an AR view of the route to be displayed by the client device. For example, the AR information may include an indication of a location where AR content is to be inserted and/or overlayed in visual media (e.g., an image or a video) of the entity location. For example, the presentation information may indicate an AR marker or other reference point for inserting the AR content associated with the route. The AR content may include information (e.g., text or graphics) to be overlaid on an image or video captured by the client device and displayed on a user interface of the client device.

As shown by reference number 130, the server device may transmit, and the client device may receive, routing AR information associated with the route to cause the AR view of the route to be displayed by the client device. For example, the client device may obtain routing AR information associated with a route through the entity location to an item location for each item included in the one or more items. In some implementations, the client device may obtain the routing information by receiving the routing AR information (e.g., from the server device). In some other implementations, the client device may obtain the routing information by generating the routing AR information (e.g., in a similar manner as described elsewhere herein).

As shown by reference number 135, the client device may determine that the client device is located proximate to (e.g., inside) the entity location. The client device may determine that the AR view of the route to be displayed by the client device based on determining that the client device is located proximate to (e.g., inside) the entity location. The client device may obtain one or more images or a video associated with the entity location. The client device may process or analyze the one or more images or the video associated with the entity location using a computer vision technique, such as an object detection technique, to identify reference points within the image(s) or video. The client device may insert or overlay AR content in the image(s) or video based on the identified reference points and/or the routing AR information. The AR content may identify the route to be taken by a user (e.g., the first user or a second user) that is associated with the client device. Alternatively, the client device may transmit, to the server device, the one or more images or the video associated with the entity location. The server device may process or analyze the one or more images or the video associated with the entity location using a computer vision technique, such as an object detection technique, to identify reference points within the image(s) or video. The server device may insert or overlay the AR content into the image(s) or video and may transmit, to the client device, the image(s) or video with the AR content inserted or overlayed.

As shown by reference number 140, the client device may provide, based on the routing AR information, an AR view of the route for display by the client device. For example, the client device may display the AR view via a user interface of the client device. As shown in FIG. 1B, the AR view may include the AR content, such as an indication of the route and/or an indication of a waypoint associated with the route. For example, in the image shown in FIG. 1B, the AR content may indicate that a user is to proceed down an aisle, stop at a waypoint (e.g., indicated by the AR waypoint overlayed in the image), and then turn right at the end of the aisle. In some implementations, the AR content may include an indication of a particular item to be retrieved at a given waypoint. For example, AR content may be overlayed in the image indicating the item (e.g., “flour”) that is to be retrieved at the waypoint indicated by the AR waypoint. In this way, the user of the client device may quickly and easily identify the route (e.g., that is determined by the server device to be an efficient route for retrieving the one or more items) and/or locations to stop along the route to retrieve the one or more items. This may conserve time associated with completing the task. Additionally, this may conserve resources (e.g., network resources, processing resources, and/or power resources) that would have otherwise been used by the client device to search for item locations associated with the one or more items to be retrieved as part of completing the task.

As shown in FIG. 1C, a user associated with the client device may arrive at a waypoint along the route and attempt to identify and/or locate an item from the one or more items. The user may use the client device to facilitate the identification of the item (e.g., to identify the location of the item and/or to identify a particular item having the one or more recommended attributes). As another example, the user identify that the item is out of stock or otherwise unavailable. The user may use the client device to facilitate the identification of a suitable replacement item.

For example, as shown by reference number 145, the client device may capture visual media (e.g., using a camera or another device associated with the client device). The visual media may include one or more images, a video, and/or live stream media (e.g., a continual video stream from the client device), among other examples. In some implementations, as shown by reference number 150, the client device may transmit, and the server device may receive, the visual media captured by the client device. In some implementations, the visual media may be associated with a first item of the one or more items that are associated with the task. For example, the client device may indicate that the first item is associated with the visual media. Alternatively, the server device may determine that the first item is associated with the visual media based on a location of the user device in connection with the route (e.g., if the client device is located near a waypoint of the route that is associated with a given item when the client device transmits the visual media, then the server device may determine that the visual media is associated with the given item). In other words, the visual media may be associated with an expected location associated with the first item.

As shown by reference number 155, the server device may analyze and/or process the visual media. In some other implementations, the client device may analyze and/or process the visual media in a similar manner as described herein (e.g., rather than the server device). The server device may analyze the visual media using a computer vision technique or another technique, such as an object detection technique. The server device may analyze the visual media to determine whether an item depicted in the visual media is the first item (e.g., is the item associated with the visual media). Additionally, or alternatively, the server device may analyze the visual media to determine one or more recommended items, associated with the first item, that are depicted in the visual media.

For example, the server device may process and/or analyze the visual media to identify one or more features of an item depicted in the visual media. The server device may compare the features of the item depicted in the visual to expected features associated with the first item to determine whether the item depicted in the visual is the first item. Additionally, or alternatively, the server device may compare the features of the item depicted in the visual to one or more recommended attributes (e.g., as determined by the server device and/or the client device as described in more detail elsewhere herein) associated with the first item to determine whether the item depicted in the visual is the first item. For example, the visual media may include multiple items that may be the first item (e.g., the first item may be a banana and the visual media may include multiple bananas). The server device may compare the features of the items depicted in the visual media to one or more recommended attributes to identify one or more suitable or acceptable items from the multiple first items depicted in the visual media. For example, the first item may be a banana, the one or more recommended attributes may include a ripeness of the banana, and the visual media may include multiple bananas. The server device may analyze the images of the multiple bananas to identify one or more bananas having a ripeness level as indicated by the one or more recommended attributes (e.g., by analyzing a color of the bananas or other features of the bananas). For example, an unripe banana may have an approximately green color, a ripe banana may have an approximately yellow color, and an overripe banana may have an approximately brown color. The server device may identify one or more suitable bananas depicted in the visual media based on analyzing the colors of the bananas.

The server device may identify suitable or acceptable items for other items based on the one or more recommended attributes of the items in a similar manner (e.g., by analyzing visual features of the items to identify particular items having the one or more recommended attributes). For example, the server device may determine whether the item depicted in the image is the first item based on whether the one or more features of the item match the one or more recommended attributes.

In some implementations, the server device may analyze the visual media to identify suitable replacement items for the first item (e.g., for the item associated with the visual media). For example, the server device may receive, from the client device, an indication that the first item is unavailable. The server device may identify one or more recommended items depicted in the visual media. For example, the server device may determine the one or more recommended items that may be suitable replacements for the first item for the first user (e.g., as described in more detail elsewhere herein). The server device may analyze the visual media to identify one or more recommended items (e.g., that are suitable replacements for the first item) depicted in the visual media. In some implementations, the server device may determine probability values or scores associated with each item of the one or more recommended items identified in the visual media (e.g., using a machine learning model and/or as described in more detail elsewhere herein).

As shown by reference number 160, the server device may generate item AR information (e.g., AR feedback information) associated with the visual media. In some other implementations, the client device may generate the item AR information (e.g., AR feedback information) associated with the visual media (e.g., such as when the client device analyzes the visual media) in a similar manner as described herein. The item AR information may include presentation information to cause AR content to be displayed in connection with the visual media. The item AR information may be associated with AR content that identifies the first item, one or more recommended first items (e.g., based on the suitable first items having one or more recommended attributes), and/or one or more replacement items, among other examples, as depicted in the visual media. For example, the item AR information may include instructions that cause the AR content to be inserted and/or overlayed in the visual media.

In some implementations, the server device may generate AR feedback information to include visual representations of respective probability values located proximate to the one or more recommended items in the visual media. The visual representations may include numbers or words (e.g., “45% probability to be accepted”), colors (e.g., a green box around items with a probability score satisfying a first threshold, a yellow box around items with a probability score satisfying a second threshold but not the first threshold, and/or a red box around items with a probability score that does not satisfy the second threshold, among other examples), and/or other indicators to represent the respective probability values. The server device may generate the AR feedback information to cause AR content, including the visual representations of respective probability values, to be inserted or overlayed in the visual media proximate to the one or more recommended items in the visual media (e.g., such that a visual representations of probability value associated with a given item is included near the given item as depicted in the visual media).

In some implementations, as shown by reference number 165, the server device may transmit, and the client device may receive, the item AR information associated with the visual media to cause AR feedback information to be displayed by the client device in connection with the visual media. For example, the AR feedback information may identify or indicate whether the item depicted in the visual media is the first item, and/or the one or more recommended items depicted in the visual media, among other examples. For example, the client device may obtain the item AR information associated with visual media captured by the client device (e.g., by receiving the item AR information from the server device or by generating the item AR information).

As shown by reference number 170, the client device may provide, based on the item AR information, AR feedback information for display in connection with the visual media. For example, in some cases, the client device may provide the visual media for display with AR content inserted or overlayed in the visual media. As shown in FIG. 1C, the AR content may identify a location of an item (e.g., the first item that is to be acquired in a location associated with the visual media). In some implementations, the AR content may identify a location of one or more suitable recommended items that have features matching the one or more recommended attributes. For example, the AR content may identify first items depicted in the visual media having a ripeness level, a color, a texture, and/or another attribute that matches the one or more recommended attributes.

Additionally, or alternatively, the AR content may identify one or more recommended items and/or replacement items depicted in the visual media. For example, the AR content may identify a location (e.g., on a shelf or other display) of an item that is a suitable replacement (e.g., suitable for the first user and/or the task as described in more detail elsewhere herein) for the first item that is to be acquired in a location associated with the visual media. In some implementations, the client device may provide for display visual representations of respective probability values located proximate to the one or more recommended items in the visual media (e.g., where the respective probability values indicate a likelihood that the first user associated with the task would accept the one or more recommended items as a replacement). In this way, a user associated with the client device may quickly and easily identify the item to be acquired and/or suitable replacement items at a given location. Additionally, be enabling the server device and/or the client device to analyze the visual media to identify items having one or more recommended attributes (e.g., that may be subjective) a likelihood that a suitable item for the first user is selected may be improved.

In some implementations, the client device (and/or the server device) may transmit, to the user device associated with the task, an indication of a recommended item, from the one or more recommended items, that was selected (e.g., based on providing the AR feedback information for display). For example, a user of the client device may identify a recommended item based on the AR feedback information displayed by the client device. The user of the client device may provide an indication to the client device of a recommended item that was selected. The client device may transmit, to the user device, a request to approve the selected recommended item. The client device may receive, from the user device, an indication of whether the recommended item is approved as a replacement for an item from the one or more items. In other words, user feedback may be incorporated to improve the likelihood that a suitable item for the first user is acquired.

As shown in FIG. 1D, and by reference number 175, the server device (and/or the client device) may determine, based on analyzing the visual media, that a first item, from the one or more items associated with the task, has been obtained. For example, the visual media may depict an image of a shopping cart or basket. The server device (and/or the client device) may analyze and/or process the visual media to determine that an item placed in the shopping cart or basket is an item (e.g., from the one or more items associated with the task) that is associated with a waypoint of the route at which the client device is currently located. For example, the server device (and/or the client device) may determine, based on analyzing the visual media, that the item depicted by the visual media is a first item from the one or more items associated with the task. Alternatively, the server device (and/or the client device) may determine, based on analyzing the visual media, that an item depicted in the visual media is a replacement item or a recommended item (e.g., from the replacement item(s) and/or recommended item(s) associated with a given item). In other words, the server device (and/or the client device) may determine, based on analyzing the visual media, that a suitable item has been selected or obtained at a current location of the client device.

As shown by reference number 180, the server device may update the routing AR information associated with the route to indicate that the first item has been obtained and to indicate a next waypoint associated with the route. For example, the next waypoint may correspond to a second item of the one or more items. The next waypoint may be identified based on an order of the waypoints associated with the route (e.g., determined by the server device as described in more detail elsewhere herein). For example, the updated routing AR information may cause AR content to be displayed indicating that a suitable item has been successfully obtained. The AR content may indicate a path and/or route to be followed by a user of the user device to reach the next waypoint associated with the route.

As shown by reference number 185, the server device may transmit, and the client device may receive, updated routing AR information to cause the client device to display an indication of the next waypoint associated with the route (e.g., based on the visual media indicating that a first item, from the one or more items, or a suitable replacement item or recommended item was obtained). As shown by reference number 190, the client device may provide the updated routing AR information for display indicating the next waypoint associated with the route (e.g., in a similar manner as described in more detail elsewhere herein, such as in connection with FIG. 1B).

In this way, the user performing the task may be enabled to quickly and easily be routed through an entity location (e.g., via the AR view of the route) to the one or more items. Additionally, the server device (e.g., a computer vision model or another machine learning model) may be trained to recognize and/or identify attributes or characteristics of items that may otherwise be subjective based on the judgement of a human. The AR feedback information may enable the user to identify a correct item having a certain desired attribute or characteristic, such as a certain level of ripeness of a fruit, among other examples. As a result, the server device may conserve time and/or resources (e.g., computing resources, network resources, and/or power resources) that would otherwise be used associated with the task being re-requested (e.g., via one or more devices) and/or re-performed by providing AR feedback to enable a user to quickly and easily identify the correct item and/or a suitable replacement item, among other examples. Additionally, the server device may conserve time associated with performing the task by efficiently routing the user through an entity location to locate the one or more items associated with the task.

As indicated above, FIGS. 1A-1D are provided as an example. Other examples may differ from what is described with regard to FIGS. 1A-1D.

FIG. 2 is a diagram of an example environment 200 in which systems and/or methods described herein may be implemented, in accordance with some embodiments of the present disclosure. As shown in FIG. 2, environment 200 may include a server device 205, a client device 210, a user device 215, and a network 220. Devices of environment 200 may interconnect via wired connections, wireless connections, or a combination of wired and wireless connections.

The server device 205 includes one or more devices capable of receiving, generating, storing, processing, providing, and/or routing information associated with real time visual feedback for AR map routing and item selection, as described elsewhere herein. The server device 205 may include a communication device and/or a computing device. For example, the server device 205 may include a server, such as an application server, a client server, a web server, a database server, a host server, a proxy server, a virtual server (e.g., executing on computing hardware), or a server in a cloud computing system, among other examples. In some implementations, the server device 205 includes computing hardware used in a cloud computing environment.

The client device 210 includes one or more devices capable of receiving, generating, storing, processing, and/or providing information associated with real time visual feedback for AR map routing and item selection, as described elsewhere herein. The client device 210 may include a communication device and/or a computing device. For example, the client device 210 may include a wireless communication device, a mobile phone, a user equipment, a laptop computer, a tablet computer, a wearable communication device (e.g., a smart wristwatch, a pair of smart eyeglasses, a head mounted display, or a virtual reality headset), or a similar type of device. In some implementations, the client device 210 and the server device 205 may be co-located. For example, the server device 205 may be included in the client device 210.

The user device 215 includes one or more devices capable of receiving, generating, storing, processing, and/or providing information associated with real time visual feedback for AR map routing and item selection, as described elsewhere herein. The user device 215 may include a communication device and/or a computing device. For example, the user device 215 may include a wireless communication device, a mobile phone, a user equipment, a laptop computer, a tablet computer, a desktop computer, a gaming console, a wearable communication device (e.g., a smart wristwatch, a pair of smart eyeglasses, a head mounted display, or a virtual reality headset), or a similar type of device.

The network 220 includes one or more wired and/or wireless networks. For example, the network 220 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 220 enables communication among the devices of environment 200.

The quantity and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300, which may correspond to the server device 205, the client device 210, and/or the user device 215. In some implementations, the server device 205, the client device 210, and/or the user device 215 include one or more devices 300 and/or one or more components of device 300. As shown in FIG. 3, device 300 may include a bus 310, a processor 320, a memory 330, an input component 340, an output component 350, and a communication component 360.

Bus 310 includes one or more components that enable wired and/or wireless communication among the components of device 300. Bus 310 may couple together two or more components of FIG. 3, such as via operative coupling, communicative coupling, electronic coupling, and/or electric coupling. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform one or more operations or processes described elsewhere herein.

Memory 330 includes volatile and/or nonvolatile memory. For example, memory 330 may include random access memory (RAM), read only memory (ROM), a hard disk drive, and/or another type of memory (e.g., a flash memory, a magnetic memory, and/or an optical memory). Memory 330 may include internal memory (e.g., RAM, ROM, or a hard disk drive) and/or removable memory (e.g., removable via a universal serial bus connection). Memory 330 may be a non-transitory computer-readable medium. Memory 330 stores information, instructions, and/or software (e.g., one or more software applications) related to the operation of device 300. In some implementations, memory 330 includes one or more memories that are coupled to one or more processors (e.g., processor 320), such as via bus 310.

Input component 340 enables device 300 to receive input, such as user input and/or sensed input. For example, input component 340 may include a touch screen, a keyboard, a keypad, a mouse, a button, a microphone, a switch, a sensor, a global positioning system sensor, an accelerometer, a gyroscope, and/or an actuator. Output component 350 enables device 300 to provide output, such as via a display, a speaker, and/or a light-emitting diode. Communication component 360 enables device 300 to communicate with other devices via a wired connection and/or a wireless connection. For example, communication component 360 may include a receiver, a transmitter, a transceiver, a modem, a network interface card, and/or an antenna.

Device 300 may perform one or more operations or processes described herein. For example, a non-transitory computer-readable medium (e.g., memory 330) may store a set of instructions (e.g., one or more instructions or code) for execution by processor 320. Processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, processor 320 may be configured to perform one or more operations or processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

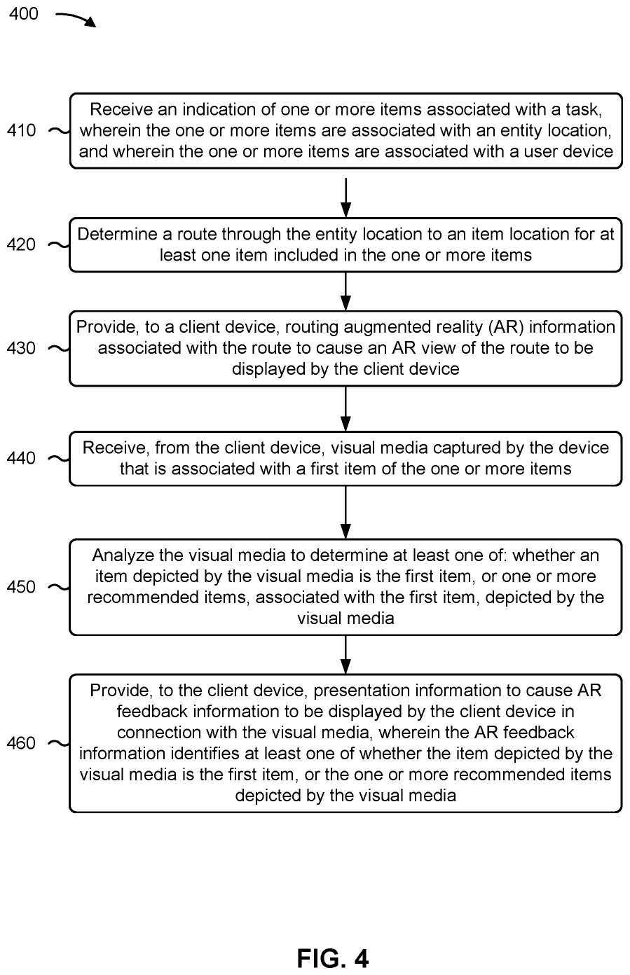

FIG. 4 is a flowchart of an example process 400 associated with real time visual feedback for AR map routing and item selection, in accordance with some embodiments of the present disclosure. In some implementations, one or more process blocks of FIG. 4 may be performed by the server device 205. In some implementations, one or more process blocks of FIG. 4 may be performed by another device or a group of devices separate from or including the server device 205, such as the client device 210 and/or the user device 215. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving an indication of one or more items associated with a task (block 410). For example, the server device 205 (e.g., using processor 320, memory 330, input component 340, and/or communication component 360) may receive an indication of one or more items associated with a task, as described above in connection with reference number 105 of FIG. 1A. As an example, the task may be associated with acquiring the one or more items on behalf of a user associated with the user device. In some implementations, the one or more items are associated with an entity location. In some implementations, the one or more items are associated with a user device.

As further shown in FIG. 4, process 400 may include determining a route through the entity location to an item location for at least one item included in the one or more items (block 420). For example, the server device 205 (e.g., using processor 320 and/or memory 330) may determine a route through the entity location to an item location for at least one item included in the one or more items, as described above in connection with reference number 120 of FIG. 1A. As an example, the server device 205 may determine an optimized route through the entity location to acquire the one or more items on behalf of a user associated with the user device.

As further shown in FIG. 4, process 400 may include providing, to a client device, routing AR information associated with the route to cause an AR view of the route to be displayed by the client device (block 430). For example, the server device 205 (e.g., using processor 320 and/or memory 330) may provide, to a client device, routing AR information associated with the route to cause an AR view of the route to be displayed by the client device, as described above in connection with reference number 130 of FIG. 1B. As an example, the server device may provide an indication of the items to be acquired to the client device 210. Further, the routing AR information may cause AR content to be displayed by the client device that guides a user of the client device along the route determined by the server device 205.

As further shown in FIG. 4, process 400 may include receiving, from the client device, visual media captured by the device that is associated with a first item of the one or more items (block 440). For example, the server device 205 (e.g., using processor 320, memory 330, input component 340, and/or communication component 360) may receive, from the client device, visual media captured by the device that is associated with a first item of the one or more items, as described above in connection with reference number 150 of FIG. 1C. As an example, the client device 210 may capture visual media at a given location (such as a waypoint along the route determined by the server device 205). The server device 205 may receive the visual media from the client device 210.

As further shown in FIG. 4, process 400 may include analyzing the visual media to determine at least one of: whether an item depicted by the visual media is the first item, or one or more recommended items, associated with the first item, depicted by the visual media (block 450). For example, the server device 205 (e.g., using processor 320 and/or memory 330) may analyze the visual media to determine at least one of: whether an item depicted by the visual media is the first item, or one or more recommended items, associated with the first item, depicted by the visual media, as described above in connection with reference number 155 of FIG. 1C and/or reference number 175 of FIG. 1D. As an example, the server device 205 may use a computer vision technique or another technique to identify a location of the first item as depicted in the visual media and/or locations of respected recommended items as depicted in the visual media.

As further shown in FIG. 4, process 400 may include providing, to the client device, presentation information to cause AR feedback information to be displayed by the client device in connection with the visual media (block 460). For example, the server device 205 (e.g., using processor 320 and/or memory 330) may provide, to the client device, presentation information to cause AR feedback information to be displayed by the client device in connection with the visual media, as described above in connection with reference number 165 of FIG. 1C. In some implementations, the AR feedback information identifies at least one of whether the item depicted by the visual media is the first item, or the one or more recommended items in the visual media. As an example, the AR feedback information may provide a real time indication to a user of the client device as to whether the first item (e.g., that is expected to be located proximate to a current location of the client device) is depicted in the visual media, a location of the first item as depicted in the visual media, and/or locations of respective recommended items as depicted in the visual media.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1D. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

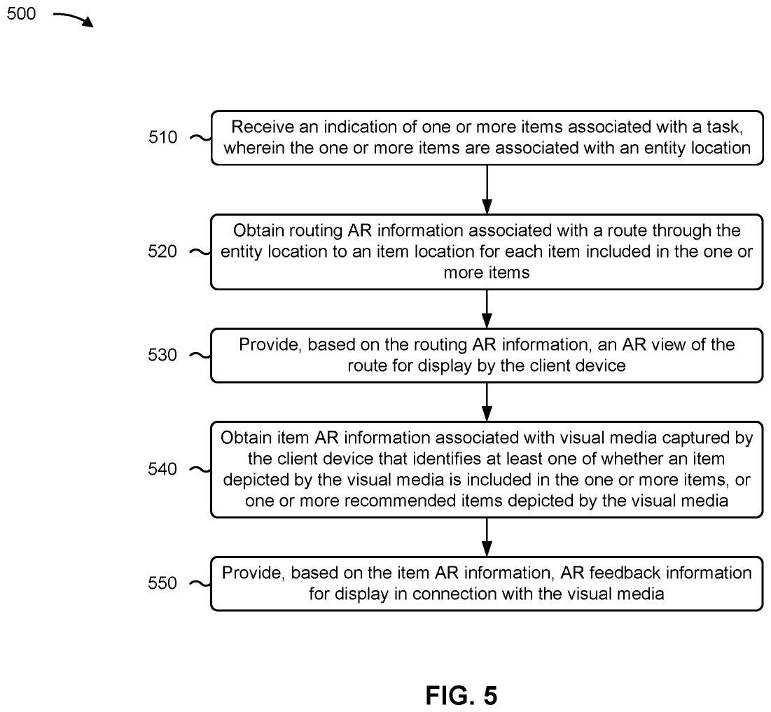

FIG. 5 is a flowchart of an example process 500 associated with real time visual feedback for AR map routing and item selection, in accordance with some embodiments of the present disclosure. In some implementations, one or more process blocks of FIG. 5 may be performed by the client device 210. In some implementations, one or more process blocks of FIG. 5 may be performed by another device or a group of devices separate from or including the client device 210, such as the server device 205 and/or the user device 215. Additionally, or alternatively, one or more process blocks of FIG. 5 may be performed by one or more components of the device 300, such as processor 320, memory 330, input component 340, output component 350, and/or communication component 360.

As shown in FIG. 5, process 500 may include receiving an indication of one or more items associated with a task (block 510). For example, the client device 210 (e.g., using processor 320, memory 330, input component 340, and/or communication component 360) may receive an indication of one or more items associated with a task, as described above in connection with reference number 105 of FIG. 1A and/or reference number 130 of FIG. 1B. In some implementations, the one or more items are associated with an entity location. As an example, the task may be associated with acquiring the one or more items on behalf of a user associated with the user device 215.

As further shown in FIG. 5, process 500 may include obtaining routing AR information associated with a route through the entity location to an item location for each item included in the one or more items (block 520). For example, the client device 210 (e.g., using processor 320 and/or memory 330) may obtain routing AR information associated with a route through the entity location to an item location for each item included in the one or more items, as described above in connection with reference number 130 of FIG. 1B. As an example, the routing AR information may include presentation information that causes AR content identifying the route to be displayed by the client device 210.

As further shown in FIG. 5, process 500 may include providing, based on the routing AR information, an AR view of the route for display by the client device (block 530). For example, the client device 210 (e.g., using processor 320 and/or memory 330) may provide, based on the routing AR information, an AR view of the route for display by the client device, as described above in connection with reference number 140 of FIG. 1B. As an example, the client device 210 may display (e.g., via a user interface) the AR view of the route to guide a user of the client device along the route to facilitate the user obtaining the one or more items.

As further shown in FIG. 5, process 500 may include obtaining item AR information associated with visual media captured by the client device that identifies at least one of whether an item depicted by the visual media is included in the one or more items, or one or more recommended items depicted by the visual media (block 540). For example, the client device 210 (e.g., using processor 320 and/or memory 330) may obtain item AR information associated with visual media captured by the client device that identifies at least one of whether an item depicted by the visual media is included in the one or more items, or one or more recommended items depicted by the visual media, as described above in connection with reference number 165 of FIG. 1C. As an example, item AR information may include presentation information that is configured to cause the client device 210 to display AR content identifying various items depicted in the visual media.

As further shown in FIG. 5, process 500 may include providing, based on the item AR information, AR feedback information for display in connection with the visual media (block 550). For example, the client device 210 (e.g., using processor 320 and/or memory 330) may provide, based on the item AR information, AR feedback information for display in connection with the visual media, as described above in connection with reference number 170 of FIG. 1C. As an example, the AR feedback information may provide real time feedback associated with the visual media captured by the client device 210. This may facilitate the user of the client device 210 to identify and/or select the correct item or a suitable replacement item at a current location of the client device 210.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1D. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for providing real time visual feedback for augmented reality (AR) map routing and item selection, the system comprising:
one or more memories; and
one or more processors, coupled to the one or more memories, configured to:
receive an indication of one or more items associated with a task, wherein the one or more items are associated with an entity location;
determine a route through the entity location to an item location for each item included in the one or more items;
transmit, to a device, routing AR information associated with the route to cause an AR view of the route to be displayed by the device;
receive, from the device, an image captured by the device that is associated with a first item of the one or more items;
analyze, using a computer vision technique or another technique, the image to determine at least one of: whether an item depicted in the image is the first item, or one or more recommended items, associated with the first item, depicted in the image; and
transmit, to the device, item AR information associated with the image to cause AR feedback information to be displayed by the device in connection with the image, wherein the AR feedback information identifies at least one of whether the item depicted in the image is the first item, or the one or more recommended items.

2. The system of claim 1, wherein the one or more processors are further configured to:
determine, for the first item, the one or more recommended items based on at least one of:
user information associated with an account that is associated with the task,
exchange history information associated with the account, or
item information associated with the first item.

3. The system of claim 2, wherein the one or more processors, to determine the one or more recommended items, are configured to:
determine one or more recommended attributes associated with the first item.

4. The system of claim 1, wherein the one or more processors, to analyze the image, are configured to:
identify one or more features of the item depicted in the image;
determine whether the one or more features match one or more recommended attributes associated with the first item, wherein the one or more recommended attributes are based on at least one of:
user information associated with a user that is associated with the task, or
exchange history information associated with the user; and
determine whether the item depicted in the image is the first item based on whether the one or more features match the one or more recommended attributes.

5. The system of claim 1, wherein the one or more processors are further configured to:
receive, from the device, an indication that the first item is unavailable,
wherein the image is associated with an expected location associated with the first item, and wherein the one or more processors, to analyze the image, are configured to:
identify the one or more recommended items in the image, wherein the one or more recommended items are alternative items to the first item; and
determine, based on at least one of user information or exchange history information associated with a user that is associated with the task, one or more probability values associated with each item of the one or more recommended items identified in the image.

6. The system of claim 5, wherein the one or more probability values indicate a likelihood that the user would accept a respective recommended item as a replacement for the first item.

7. The system of claim 5, wherein the AR feedback information includes visual representations of respective probability values located proximate to the one or more recommended items in the image.

8. The system of claim 1, wherein the one or more processors are further configured to:
receive, from the device, an indication that the first item is unavailable; and
determine, for a recommended item of the one or more recommended items, at least one of:
a quantity of the recommended item,
one or more attributes of the recommended item, or
a brand associated with the recommended item,
wherein the one or more recommended items are replacement items for the first item.

9. A method for providing real time visual feedback for augmented reality (AR) map routing and item selection, comprising:
receiving, by a device, an indication of one or more items associated with a task, wherein the one or more items are associated with an entity location, and wherein the one or more items are associated with a user device;
determining, by the device, a route through the entity location to an item location for at least one item included in the one or more items;
providing, by the device and to a client device, routing AR information associated with the route to cause an AR view of the route to be displayed by the client device;
receiving, by the device and from the client device, visual media captured by the device that is associated with a first item of the one or more items;
analyzing, by the device, the visual media to determine at least one of: whether an item depicted by the visual media is the first item, or one or more recommended items, associated with the first item, depicted by the visual media; and
providing, by the device and to the client device, presentation information to cause AR feedback information to be displayed by the client device in connection with the visual media, wherein the AR feedback information identifies at least one of whether the item depicted by the visual media is the first item, or the one or more recommended items in the visual media.

10. The method of claim 9, wherein determining the route comprises:
obtaining layout information associated with the entity location;
determining the item location for each item included in the one or more items based on the layout information; and
determining one or more waypoints, associated with the route, corresponding to the item location for each item included in the one or more items; and
determining an order of the one or more waypoints based on the layout information.

11. The method of claim 9, further comprising:
determining, based on analyzing the visual media, that the item depicted by the visual media is the first item;
updating the routing AR information associated with the route to indicate that the first item has been obtained and to indicate a next waypoint associated with the route, wherein the next waypoint corresponds to a second item of the one or more items; and
transmitting, to the client device, updated routing AR information to cause the client device to display an indication of the next waypoint associated with the route.

12. The method of claim 9, wherein the visual media includes at least one of:
an image,
a video, or
live stream media.

13. The method of claim 9, further comprising:
determining, for the first item, the one or more recommended items based on at least one of:
user information associated with a user that is associated with a user device,
exchange history information associated with the user, or
item information associated with the first item.

14. The method of claim 9, wherein analyzing the visual media comprises:
identifying one or more features of the item depicted by the visual media;
determining whether the one or more features match one or more recommended attributes associated with the first item, wherein the one or more recommended attributes are based on at least one of:
user information associated with a user that is associated with the user device, or
exchange history information associated with the user; and
determining whether the item depicted by the visual media is the first item based on whether the one or more features match the one or more recommended attributes.

15. The method of claim 14, wherein the one or more recommended attributes include at least one of:
a size of the first item,
a quantity of pieces associated with the first item,
a ripeness level associated with the first item, or
a color associated with the first item.

16. The method of claim 9, further comprising:
receiving, from the device, an indication that the first item is unavailable,
wherein the visual media is associated with an expected location associated with the first item, and wherein analyzing the visual media comprises:
identifying the one or more recommended items in the visual media, wherein the one or more recommended items are alternative items to the first item;
determining, based on at least one of user information or exchange history information associated with a user that is associated with the task, probability values associated with each item of the one or more recommended items identified in the visual media; and
generating the AR feedback information to include visual representations of respective probability values located proximate to the one or more recommended items in the visual media.

17. A non-transitory computer-readable medium storing a set of instructions, the set of instructions comprising:
one or more instructions that, when executed by one or more processors of a client device, cause the client device to:
receive an indication of one or more items associated with a task, wherein the one or more items are associated with an entity location;
obtain routing augmented reality (AR) information associated with a route through the entity location to an item location for each item included in the one or more items;
provide, based on the routing AR information, an AR view of the route for display by the client device;
obtain item AR information associated with visual media captured by the client device that identifies at least one of whether an item depicted by the visual media is included in the one or more items, or one or more recommended items depicted by the visual media; and
provide, based on the item AR information, AR feedback information for display in connection with the visual media.

18. The non-transitory computer-readable medium of claim 17, wherein the visual media includes one or more recommended items associated with the one or more items, and wherein the one or more instructions, that cause the client device to provide the AR feedback information for display, cause the client device to:
provide for display visual representations of respective probability values located proximate to the one or more recommended items in the visual media, wherein the respective probability values indicate a likelihood that a user associated with the task would accept the one or more recommended items as a replacement.

19. The non-transitory computer-readable medium of claim 17, wherein the one or more instructions, that cause the client device to provide the AR view of the route for display, cause the client device to:
receive updated routing AR information indicating a next waypoint associated with the route based on the visual media indicating that a first item, from the one or more items, was obtained, wherein the next waypoint corresponds to a second item of the one or more items; and
provide the updated routing AR information for display indicating the next waypoint associated with the route.

20. The non-transitory computer-readable medium of claim 17, wherein the one or more instructions further cause the client device to:
transmit, to a user device associated with the task, an indication of a recommended item, from the one or more recommended items, that was selected based on providing the AR feedback information for display; and
receive, from the user device, an indication of whether the recommended item is approved as a replacement for an item from the one or more items.
